(19) United States
(12) Patent Application Publication
(10) Pub. No.: US 2024/0304942 A1
(43) Pub. Date: Sep. 12, 2024

(54) Separators For Lithium Batteries

(71) Applicant: Meta Materials Inc., North Billerica, MA (US)

(72) Inventors: Chandrakant C. Patel, Burlington, MA (US); Steven A. Carlson, Cambridge, MA (US)

(21) Appl. No.: 18/596,588

(22) Filed: Mar. 5, 2024

Related U.S. Application Data
(60) Provisional application No. 63/488,560, filed on Mar. 6, 2023.

(51) Int. Cl. H01M 50/403; H01M 4/133; H01M 4/587; H01M 50/426; H01M 50/446; H01M 4/02

(52) U.S. Cl. CPC H01M 50/403; H01M 4/133; H01M 4/587; H01M 50/426; H01M 50/446; H01M 2004/021

(57) ABSTRACT

A separator for a lithium battery is a coating of an inorganic oxide (for example, aluminum oxide) and an organic polymer (for example, polyvinylidene difluoride (PVdF)). In a method, the separator is formed on an electrode material layer (for example, graphite) of an anode electrode. In a first pre-wetting step, a first liquid comprising a first volatile liquid is applied to the electrode material such that pores in the material are filled. In a second step, a second liquid is applied over the first liquid. The second liquid includes inorganic oxide particles and the organic polymer dispersed in a second volatile liquid. The first and second volatile liquids are then substantially removed (for example, by evaporation in a drying oven) thereby leaving the separator coating on the electrode material of the anode, and leaving the pores filled with a gel or solid electrolytic polymer material.

### CROSS REFERENCE TO RELATED APPLICATION

This application claims the benefit under 35 U.S.C. § 119(e) from U.S. Provisional Application No. 63/488,560, entitled “Separators For Lithium Batteries,” filed on Mar. 6, 2023. The entirety of the disclosure of the foregoing document is incorporated herein by reference.

### TECHNICAL FIELD

The technologies described in the present disclosure relate to energy production. More particularly, the disclosure relates to batteries having a separator coated onto one or more electrodes.

### BACKGROUND INFORMATION

A key safety feature of modern lithium battery cells is a separator, which is typically a thin, porous membrane that physically separates an anode material from a cathode material and that serves to prevent physical contact between anode material and cathode material while allowing ion transport in a cell of the battery. Lithium battery cells are known to include multiple separators between a cathode material and an anode material to prevent unacceptably high levels of self-discharge and/or lower battery yields, for example, as may arise due to pinholes and/or small voids or near-voids resulting from non-uniform separator layers, in particular when a process of coating a separator layer onto a dry electrode material is used.

### SUMMARY

It has been discovered that a process of adding a robust, single separator layer to electrode material forming an electrode of a battery can be achieved through a process of applying a first liquid and then a second liquid to the electrode material followed by removing volatile components of each of the first liquid and second liquid via a liquid removal process. This discovery has been exploited to develop the present disclosure, which, in part, is directed to batteries, systems making batteries, methods of making them.

In one aspect, a method for making a lithium battery includes applying a first liquid to an electrode material and then applying a second liquid to the electrode material. The first liquid includes a first volatile liquid. The second liquid includes a second volatile liquid, an inorganic oxide, and an organic polymer to the electrode. At least some of the first volatile liquid and the second volatile liquid are removed from the electrode material to form a separator coated directly on the electrode material.

In another aspect, a lithium battery is made according to the method of the previous aspect.

In another aspect, a lithium battery includes an electrode material and a single separator layer coated directly unto the electrode material.

In another aspect, the single separator layer of the lithium battery of the previous aspect has been deposited by a process that includes applying a first liquid to the electrode material and then applying a second liquid to the electrode material. The first liquid includes a first volatile liquid. The second liquid includes a second volatile liquid, an inorganic oxide, and an organic polymer. At least some of the first volatile liquid and the second volatile liquid are removed to form the single separator layer coated directly unto the electrode material.

Further examples, which are applicable to any of these aspects include, but are not limited to, the following features, which can be included in any feasible combination.

In one example, the removing of at least some of the first volatile liquid and the second volatile liquid includes applying heat.

In another example, the lithium battery does not include a polyolefin separator, a non-woven separator or a fibrous separator.

In another example, the first liquid includes about 100% by weight of the first volatile liquid, or at least about 90% by weight of the first volatile liquid, or at least about 70% by weight of the first volatile liquid.

In another example, the first volatile liquid includes an organic carbonate, which can optionally include propylene carbonate.

In another example, the first liquid further includes inorganic electrolyte particles, a solid polymer electrolyte, a gel polymer electrolyte, and/or a first organic polymer. The first organic polymer can optionally include a polymer such as polyvinylidene difluoride and/or copolymers thereof.

In another example, the second volatile liquid includes N-methyl pyrrolidone and/or propylene carbonate.

In another example, the inorganic oxide includes a hydrated aluminum oxide.

In another example, the organic polymer of the second liquid includes a polymer such as of polyvinylidene difluoride and/or copolymers thereof.

In another example, the separator or the single separator layer has a thickness of about 2 to about 20 microns, or of about 2 to about 9 microns, or of about 2 to about 5 microns.

In another example, the electrode material includes pores, and the first liquid fills the pores of the electrode material.

In another example, the electrode material includes or forms an anode and/or the electrode material includes or forms a cathode.

In another example, the lithium battery does not include any of a polyolefin separator, a non-woven separator, or a fibrous separator, and the first liquid includes one or more materials such as solid inorganic electrolyte particles, a solid polymer electrolyte, a gel polymer electrolyte, and/or an organic polymer.

Further details and embodiments and methods and techniques are described in the detailed description below. This summary does not purport to define the invention. The invention is defined by the claims.

### BRIEF DESCRIPTION OF THE DRAWINGS

The foregoing and other objects of the present disclosure, the various features thereof, as well as the disclosure itself may be more fully understood from the following description, when read together with the accompanying drawings in which:

FIG. 1 is a schematic representation of a method of forming a separator coating consistent with certain aspects of the current disclosure.

### DETAILED DESCRIPTION

The disclosures of these patents, patent applications, and publications in their entireties are hereby incorporated by reference into this application in order to more fully describe the state of the art as known to those skilled therein as of the date of the invention described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group, unless otherwise indicated.

For the purposes of explaining the invention, well-known features of lithium battery technology known to those skilled in the art of lithium batteries have been omitted or simplified in order not to obscure the basic principles of the invention. Parts of the following description will be presented using terminology commonly employed by those skilled in the art of battery design. It should also be noted that in the following description of the invention repeated usage of the phrase “in one embodiment” or “in one example” does not necessarily refer to the same embodiment or example.

As used herein, the articles “a” and “an” refer to one or to more than one (i.e., to at least one) of the grammatical object of the article. By way of example, “an element” means one element or more than one element. Furthermore, use of the term “including” as well as other forms, such as “include,” “includes,” and “included,” is not limiting.

As used herein, the term “about” will be understood by persons of ordinary skill in the art and will vary to some extent on the context in which it is used.

As used herein when referring to a measurable value such as an amount, a temporal duration, and the like, the term “about” is meant to encompass variations of ±20% or ±10%, including ±5%, ±1%, and ±0.1% from the specified value, as such variations are appropriate to perform the disclosed methods.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.”

Use of the term “based on,” above and in the claims is intended to mean, “based at least in part on,” such that an unrecited feature or element is also permissible.

The implementations set forth in the following description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described below can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

The current disclosure relates to lithium batteries that include a separator that is coated directly on the electrode material of a lithium battery. This is the only separator for a given pair of anode and cathode materials in the lithium battery and does not require another separator to be added to the pair in order to safely and effectively isolate anode and cathode materials from one another. It will be understood that a battery including multiple instances of anodes and cathodes can be implemented consistent with the current disclosure to include a single separator as described herein provided between each instance of anode and cathode such that the battery as a whole includes multiple separators, but not multiple separator layers applied to a same pair of electrode materials.

In certain conventional approaches, it is useful to coat a separator layer on the electrode after calendering of the electrode material. Calendering is a compaction process via which the porosity of the electrode material is reduced so as to improve particle contact and thus enhance the energy density of the battery. Conventional lithium battery electrodes, however, are typically about 20% to about 40% porous even after calendering. This high porosity may create several challenges in coating a separator directly on the dry electrode material.

One challenge that frequently arises in coating a separator directly on a dry electrode is uneven diffusion of the separator coating into the non-uniform pore structure of the electrode. This uneven diffusion may result in very thin or near-void coating thickness areas or spots of the separator that fail to effectively insulate an anode and a cathode from each other in the lithium battery. Further, the uneven penetration of the separator coating into the electroactive layer of the dry electrode can result in inconsistent battery cycling performance.

Another challenge in coating a separator directly on the material of a dry electrode is the air in the pores of the electrode. When the separator coating is directly applied to the electrode and then heated to remove the volatile liquids, the air in the pores expands in volume and forces its way through the separator coating. This phenomenon forms pinholes of differing sizes in the separator coating upon drying. These pinholes can compromise the insulation performance of the separator and require a second separator to be included with each electrode instead of just one separator directly coated on the electrode.

In one or more approaches disclosed herein such challenges may be overcome by pre-wetting the pores of the electrode with a liquid that fills the pores of the electrode material, and then subsequently removing liquid from (i.e., causing removal of one or more volatile liquid components applied to the electrode material) the pre-wetted electrode after the separator coating has been applied. The removal of liquid (e.g., drying), can occur via a liquid removal process, such as, but not limited to, applying heat. Another possible advantage of such approaches is that the pre-wetting step can be used to deliver electrolyte materials, such as, but not limited to, solid inorganic electrolyte materials, into the pores of the electrode. In one example, pre-wetting is used to deliver organic polymer binder into very thick dry battery electrode coatings where this electroactive electrode material is in a dry state with no liquid solvent and little or no polymer binder. Benefits that can be achieved from this approach include added cohesive strength and durability during battery cycling when the electrode layers undergo the stresses of changes in their thickness.

In one aspect of the disclosure, a lithium battery, such as, but not limited to, a lithium ion battery, a solid state lithium ion battery, or a solid state lithium metal battery, is prepared at least in part by applying a first liquid that includes a first volatile liquid to an electrode. Then, a second liquid that includes a second volatile liquid, an inorganic oxide, and an organic polymer is applied to the electrode. A liquid removal process, such as, but not limited to, heating, vacuum evaporation, other processes for causing evaporation of volatile liquids, and any such processes in feasible combinations, then results in removal of significant amounts (optionally all) of the first volatile liquid and the second volatile liquid from the electrode material. Removal of the first volatile liquid and the second volatile liquid in this manner results in a separator coated directly on the electrode. This method of making a lithium battery does not require the use of additional separators to provide an acceptable insulation and excellent (e.g., very low) self-discharge performance. In some examples, the first and second volatile liquids can be a same volatile liquid or a different volatile liquid.

In one example, a lithium battery made by the methods described herein does not include any of a polyolefin separator, a non-woven separator, and/or a fibrous separator. A separator coating consistent with the current disclosure includes a dispersion of an inorganic pigment or particle and an organic polymer and differs from non-woven separators. For example, polyolefin separators are extruded, while non-woven separators and fibrous separators are wet laid or dry laid.

As described herein, it is useful to fill the pores of the electrode so as to reduce or even completely avoid unwanted air entrapment and/or diffusion of the second volatile liquid into the electrode. In one example, the first liquid, which includes a first volatile liquid and optionally one or more of inorganic electrolyte particles and/or a solid polymer electrolytes, fills the pores of the electrode material prior to addition of the second liquid, which includes a second volatile liquid as well as an inorganic oxide and organic polymer and/or one or more polymer precursor materials that form the separator coating as a result of removing the first and second volatile liquids via the removal process. The first liquid can optionally further include electrolytic solids, that are thereby drawn into the porous matrix of the electrode material with the first volatile liquid and may also be brought close to an outside surface of the electrode material. When the first volatile liquid is removed, these electrolytic solids remain behind, in the pores of the electrode material and/or on its surface. Addition of such electrolytic solids in this manner can improve the conductive properties of the resultant electrode as an additional benefit.

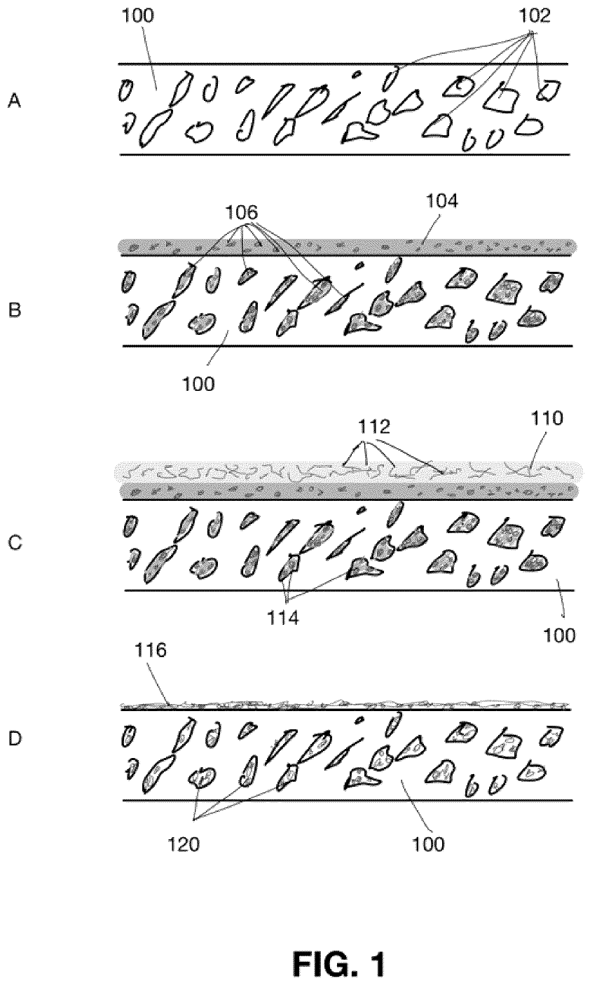

FIG. 1 is a diagram of an example of a method of forming a separator coating on an electrode, wherein in carrying out the method pores in the electrode material of the electrode are filled with a solid or gel polymer electrolyte.

In a first step of the method shown in panel A, an uncoated electrode of electrode material 100 has various internal pores 102. In one example the electrode material is a layer of dry graphite of an anode electrode. The anode electrode comprises a thin central metal foil layer (for example, copper) that is coated on both sides with graphite, with the anode having been calendered using a two roller compactor.

In a second step of the method (a pre-wetting step) shown in panel B, an amount of a first liquid 104 (shown as a grey material that includes dispersed dark dots) includes a first volatile liquid. portion (the illustrated darker grey portion of 104) and an electrolytic solids portion 106 (the dark dots portion 106 of 104), is applied such that an outer surface of the electrode material is coated and such that the pores 102 are also at least partially filled by the first liquid 104 (the liquid and the electrolytic solids). In one example, the first volatile liquid portion is propylene carbonate (PC). In another example, the first liquid 104 includes just the first volatile liquid portion and no electrolytic solids portion.

In a third step of the method shown in panel C, a second liquid 110 (shown as a lighter grey material that includes dispersed wavy lines) that includes a second volatile liquid portion (the illustrated lighter grey portion of 110) and an inorganic oxide and an organic polymer and/or polymer precursors 112 (the dark green wavy lines portion 112 of 110) is applied over the structure shown in panel B. In one example, the second volatile liquid portion is a blend of N-methyl pyrrolidone (NMP) and propylene carbonate (PC). In one example, the inorganic oxide is hydrated aluminum oxide particles of a particle size of about 85 nm in diameter. In one example, the organic polymer is a binder and is polyvinylidene difluoride (PVdF). The second volatile liquid portion (NMP and PC) functions as a solvent, with the PVdF organic polymer binder being dissolved in it.

In a fourth step of the method shown in panel D, the first and second volatile liquids are removed, leaving a separator layer 116 (also called a separator coating) on the surface of the electrode material 100. The resulting separator layer 116 is formed from and comprises the inorganic oxide and the organic polymer and/or polymer precursors 112 (and may also include electrolytic solids 106), and pores 120 containing electrolytic solids 106. In the resulting separator layer 116, the organic polymer functions as a binder to bind the inorganic oxide particles together, and to bind the separator layer 116 to the surface of the electrode material. In one example, the first and second volatile liquids are removed by moving the coated electrode through a 300° F. drying oven so that it is in the drying oven long enough to evaporate off most or all of the first and second volatile liquids. The separator layer 116 can be further heat treated in the oven. In one example, the oven is a 300° F. drying oven.

As is apparent to the skilled artisan reading this disclosure, discussions of electrodes and separators applied thereto are equally applicable to both anode and cathode materials used in lithium batteries. In addition to the advantages discussed above, the pre-wetting of the electrode by the first liquid also enables the delivery of useful materials into either or both of anodes and cathodes for solid state and semi-solid state lithium batteries. In one example, the first liquid includes, in addition to the first volatile liquid, inorganic electrolyte particles, such as inorganic electrolyte oxide particles and inorganic electrolyte sulfide particles. In one example, the first liquid comprises a solid polymer electrolyte. In one example, the first liquid includes a gel polymer electrolyte. In another example, the first liquid includes an organic polymer and/or a polymer precursor. In certain examples, the first liquid and the second liquid may both include an organic polymer and/or an organic polymer precursor. In different example implementations of the current subject matter, the organic polymer and/or organic polymer precursor in the first liquid and the organic polymer and/or organic polymer precursor in the second liquid may be a same composition or a different composition. Examples of an organic polymer can include, but are not limited to, polyvinylidene difluoride (PVdF) and/or a copolymer thereof. Examples of an organic polymer precursor can include, but are not limited to, an acrylate monomer that may be polymerized by heat or photons to form an organic polymer.

The methods of making a lithium battery disclosed herein are not limited to the use of about 100% by weight of the first volatile liquid in the first liquid. In one example, the first volatile liquid comprises at least about 100% by weight of the first liquid. In a further example, the first volatile liquid comprises at least about 90% by weight of the first liquid. In yet a further example, the first volatile liquid comprises at least about 70% by weight of the first liquid.

A variety of volatile liquids may be used in the first liquid. One requirement is that the first volatile liquid does not significantly disrupt the quality of the electrode by dissolving or significantly swelling the electrode layer. In one example, the first volatile liquid comprises an organic carbonate. In a further example, the first volatile liquid comprises propylene carbonate.

Volatile liquids utilized in separator coatings may be used as the second volatile liquid. In one example, the second volatile liquid includes, but is not limited to, N-methyl pyrrolidone (NMP). In a further example, the second volatile liquid includes, but is not limited to, propylene carbonate.

In one example, the inorganic oxide includes a hydrated aluminum oxide. In another example, the organic polymer includes a polymer, such as, but not limited to, polyvinylidene difluoride and copolymers thereof.

Various separator coatings are suitable for the methods disclosed herein. In one example, the separator layer is derived from a separator coating formulation used to make polymer-reacted hydrated aluminum oxide separators, such as, but not limited to, those sold by Meta Materials of Halifax, Nova Scotia, under the tradename of NPORE. In some non-limiting examples, separator coatings are about 40% to about 55% porous and/or include, but are not limited to, a xerogel coating layer with a narrow pore size distribution centered at a diameter from about 8 nm to about 100 nm.

It is useful to reduce the thickness of separators as much as possible without compromising the insulation and mechanical durability properties of the separators. A potential advantage of coating the separator directly on the electrode (e.g., on the electrode material itself after calendering of the electrode material) is that the separator may have a much lower thickness than the typical 10 micron to 20 micron thickness of conventional separators, because the separator does not have to provide the high mechanical strength for the winding processes of the cell assembly. In one example, the separator has a thickness of about 2 microns to about 20 microns. In a further example, the separator has a thickness of 2 microns to about 9 microns. In yet a further example, the separator has a thickness of about 2 microns to about 5 microns.

In another aspect of the disclosure, a lithium battery, such as, but not limited to, a lithium ion battery, a solid state lithium ion battery, a solid state lithium metal battery, a semi-solid state lithium ion battery, or the like, can be made by a method that includes applying a first liquid that includes a first volatile liquid to an electrode, then applying a second liquid (that includes a second volatile liquid, an inorganic oxide, and an organic polymer) over the applied first liquid. The first volatile liquid and the second volatile liquid are then removed in a removal process, such as, but not limited to, by heating the electrode material and applied liquids (optionally under vacuum), to form a separator layer that is coated directly on the electrode. The first liquid can include, in certain examples, at least about 90% by weight of the first volatile liquid.

In another aspect of the disclosure, a lithium battery, such as, but not limited to, a lithium ion, a solid state lithium ion, or a solid state lithium metal battery, can be made by applying a first liquid that includes a first volatile liquid to an electrode material. Then, a second liquid that includes a second volatile liquid, an inorganic oxide, and an organic polymer is applied over the first liquid on the electrode material. A liquid removal process, such as, but not limited to, applying heat substantially removes the first volatile liquid and the second volatile liquid, thereby forming a separator coated directly on the electrode. The lithium battery does not include a separator such as a polyolefin separator, a non-woven separator, or a fibrous separator. The first liquid includes at least about 70% by weight of the first volatile liquid and also includes solid inorganic electrolyte particles, a solid polymer electrolyte, a gel polymer electrolyte, and/or an organic polymer.

In one example, a lithium battery, such as, but not limited to, a lithium ion, a solid state lithium ion, or a solid state lithium metal battery can made by any of the methods disclosed herein, including the combination of various methods and product designs described herein.

The methods disclosed herein can be applied to other product applications for a nanoporous xerogel membrane, such as for nanofiltration membranes where the nanoporous membrane is coated directly on some type of filtration membrane comprising pore diameters greater than about 100 nm.

The methods described herein can be performed, for example, with a production coating machine having two coating stations, where pre-wetting (e.g., application of the first liquid) is done on the first coating station, and the pre-wetted electrode is conveyed rapidly to the second coating station, with no or at least very minimal drying. The separator coating (e.g., the second liquid) is applied at the second coating station, and the separator/electrode assembly is heated or otherwise treated with a liquid removal process to remove the first volatile liquid and the second volatile liquid. In one example, the pre-wetting (e.g., application of the first liquid) and the application of the separator coating (e.g., the second liquid) can be done at a single coating station with two coating applications before going into a drying oven or other liquid removal process. Another example process includes a dual coating application, such as with a dual slot die coating application.

In one aspect of the disclosure, a lithium battery comprises an electrode; and a single separator layer coated directly unto the electrode. The separator may be coated onto material forming the electrode by any of the methods disclosed herein. In exemplary implementations, the separator exhibits no pinholes or voids in the separator layer and no very thin spots of separator coating on the anode and/or on the cathode. For example, for use in lithium and other batteries, the separator needs to have no pinholes or voids and no very thin areas that cause an elevated rate of self-discharge of the battery. The minimal rate of self discharge for a certain number of days at a certain temperature is a key part of the separator specifications for each specific battery. Any pinholes or voids in the separator and any excessive amount of thin areas in the separator that result in elevated levels of self-discharge will cause the separator to be rejected for commercial use.

In one exemplary battery, an anode with an about 70 micron thick dry graphite active coating (e.g., an electrode material) is coated with a 100% propylene carbonate solution with a #5 Meyer rod to fill the pores of the anode active layer. Next, an about 16% solids by weight coating of a hydrated aluminum oxide with an average primary particle size of about 85 nm in diameter is blended in about a 3:1 hydrated aluminum oxide to functionalized polyvinylidene difluoride (Solef 5140 PVdF supplied by Solvay) by weight ratio in an about 70/30 by weight blend of N-methyl pyrrolidone (NMP) to propylene carbonate (PC). The pre-wet coating and the separator coating are dried at the same time in a convection oven at 300° F. for about 2 minutes. The thickness of the separator coating is about 5 microns with a coating weight of about 7 grams per square meter. The coating exhibits no pinholes or voids in the separator layer and no very thin spots of separator coating on the anode, so that the battery with that separator passes the self-discharge requirements, as described above.

In an exemplary control experiment, a battery is made as in the method discussed in the paragraph above without the pre-wetting step, which results in many pinholes or voids in the separator coating and in a number of very thin spots of separator coating on the anode, such that the separator coating defects result in the battery failing the self-discharge requirements, as described above, and also is difficult to charge efficiently because of rapid self-discharge.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A method comprising the steps of:
(a) applying a first liquid to an electrode material, wherein the first liquid comprises a first volatile liquid;
(b) applying a second liquid over the first liquid when the first liquid is on the electrode material, wherein the second liquid comprises a second volatile liquid, an inorganic oxide, and an organic polymer; and
(c) removing at least some of the first volatile liquid and some of the second volatile liquid from the electrode material to form a separator coated directly on the electrode material, wherein the separator comprises the inorganic oxide and the organic polymer.

2. The method of claim 1, wherein the electrode material comprises graphite.

3. The method of claim 1, wherein the electrode material has pores, and wherein the first liquid prior to step (c) fills at least some of the pores of the electrode material.

4. The method of claim 1, wherein the electrode material has pores, and wherein after step (c) at least some of the pores are at least partially filled with a solid polymer electrolyte.

5. The method of claim 1, wherein the electrode material has pores, and wherein after step (c) at least some of the pores are at least partially filled with a gel polymer electrolyte.

6. The method of claim 1, wherein the removing of step (c) comprises applying heat.

7. The method of claim 1, wherein the first volatile liquid comprises an organic carbonate.

8. The method of claim 1, wherein the first volatile liquid is propylene carbonate.

9. The method of claim 1, wherein the first liquid further comprises inorganic electrolyte particles.

10. The method of claim 1, wherein the organic polymer of the second liquid contains fluorine atoms.

11. The method of claim 1, wherein the organic polymer of the second liquid is selected from the group consisting of polyvinylidene difluoride and copolymers thereof.

12. The method of claim 1, wherein the second volatile liquid comprises N-methyl pyrrolidone.

13. The method of claim 1, wherein the second volatile liquid comprises propylene carbonate.

14. The method of claim 1, wherein the inorganic oxide comprises oxide particles, and wherein the oxide particles comprise a metal.

15. The method of claim 1, wherein the electrode material in step (a) is part of an electrode, wherein the electrode comprises a layer of a metal, and wherein the electrode material is disposed on the layer of the metal.

16. A coated electrode structure comprising:
a layer of metal;
a layer of electrode material disposed on the layer of metal, wherein the layer of electrode material has pores;
electrolytic solid or gel pore-filling material, wherein the electrolytic solid or gel pore-filling material at least partially fills at least some of the pores; and
a separator coating disposed directly on the electrode material, wherein the separator coating comprises inorganic oxide particles and an organic polymer binder.

17. The coated electrode structure of claim 16, wherein the electrode material comprises graphite, and wherein the pores have a pore size distribution centered at a diameter from 8 nm to 100 nm.

18. The coated electrode structure of claim 16, wherein the organic polymer binder comprises fluorine.

19. A coated electrode structure comprising:
a layer of metal;
a layer of graphite disposed on the layer of metal, wherein the layer of graphite has pores;
means for at least partially filling at least some of the pores; and
a separator coating disposed directly on the electrode material, wherein the separator coating comprises inorganic oxide particles and an organic polymer.

20. The coated electrode structure of claim 19, wherein the pores have a pore size distribution centered at a diameter from 8 nm to 100 nm, wherein the means comprises a solid electrolyte material or a gel electrolyte material.
